(19) United States
(12) Patent Application Publication
(10) Pub. No.: US 2008/0074058 A1
(43) Pub. Date: Mar. 27, 2008

(54) DC/DC CONVERTER AND CONTROLLER THEREOF

(75) Inventors: Li-Min Lee, Taipei City (TW); Chung-Che Yu, Taipei City (TW); Chien-Pang Hung, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: BEYOND INNOVATION TECHNOLOGY CO., LTD., Taipei City (TW)

(21) Appl. No.: 11/615,001

(22) Filed: Dec. 22, 2006

(30) Foreign Application Priority Data
Sep. 26, 2006 (TW) 95135514

(51) Int. Cl. H05B 41/36

(52) U.S. Cl. 315/291

(57) ABSTRACT

A DC/DC converter for driving a load is provided. The DC/DC converter includes an inductor, a switch, a capacitor and a rectifier element. The switch and the inductor are coupled in series between a first common level and a second common level. The capacitor and the rectifier element are coupled in series between the first and second terminal of the switch or the inductor. The load is coupled between a coupling point of the capacitor and rectifier element and the second common level, wherein the coupling point of the capacitor and rectifier element outputs an output voltage to drive the load. A control terminal of the switch is switched between open circuit state and short circuit state according to a control signal.

### CROSS-REFERENCE TO RELATED APPLICATION

This application claims the priority benefit of Taiwan application serial no. 95135514, filed on Sep. 26, 2006. All disclosure of the Taiwan application is incorporated herein by reference.

### BACKGROUND OF THE INVENTION

1. Field of the Invention

The present invention relates to a DC/DC converter and a controller thereof. More particularly, the present invention relates to a DC/DC converter capable of providing both boost function and buck function, and a controller thereof.

2. Description of Related Art

Cold cathode fluorescent lamps are usually used as light sources in conventional backlight devices. However, with the progress of photoelectric technology in recent years, light emitting diodes (LEDs), due to the advantages such as small size, low operating voltage, long life and high color saturation, have become new options for the light sources of the backlight devices.

LEDs are driven by a DC voltage. In order to ensure uniform luminance of all LEDs, conventionally, the LEDs are connected in series, such that the currents flowing through all of the LEDs are the same. FIG. 1 shows a conventional LED driving circuit using a boost circuit. Referring to FIG. 1, the circuit includes a controller 110 and a boost converter circuit. The boost converter circuit includes an inductor 121, a switch 122, a diode 123 and a capacitor 124. The switch 122 is switched between open circuit state and short circuit state according to a control signal provided by the controller 110. When the switch 122 is situated in the short circuit state, the inductor 121 stores the power from the input voltage. When the switch 122 is situated in the open circuit state, the inductor 121 transmits the stored power to the capacitor 124 through the diode 123. The capacitor 124 stores the power from the inductor 121 and generates an output voltage, so as to drive a set of LEDs 130 to emit light. A resistor 141 is connected to the set of LEDs 130 for detecting the magnitude of the current flowing through the set of LEDs 130, and generating a feedback signal which is fed back to the controller 110. The controller 110 regulates a pulse width of the control signal according to the feedback signal, so as to control the current flowing through the set of LEDs 130 at a stable value, such that the set of LEDs 130 emits light stably. The voltage conversion factor (output voltage/input voltage) of the boost circuit is 1/(1−D), where D is a duty cycle of the control signal. Therefore, the boost circuit cannot output an output voltage lower than the input voltage.

FIG. 2 shows a conventional LED driving circuit using a buck circuit. Referring to FIG. 2, the circuit includes a controller 210 and a buck converter circuit. The buck converter circuit includes an inductor 221, a switch 222, a diode 223 and a capacitor 224. When the switch 222 is situated in the short circuit state, the input voltage supplies power to the inductor 221 and the capacitor 224, and when the switch 222 is situated in the open circuit state, the inductor 221 transmits the stored power to the capacitor 224 through the diode 223. The capacitor 224 stores the power from the inductor 221 and generates an output voltage to drive a set of LEDs 230 to emit light. A resistor 241 is connected to the set of LEDs 230 for detecting the magnitude of the current flowing through the set of LEDs 230, and generating a feedback signal which is fed back to the controller 210. The controller 210 regulates a pulse width of the control signal according to the feedback signal, so as to control the current flowing throgh the set of LEDs 230 at a stable value, such that the set of LEDs 230 emits light stably. The voltage conversion factor (output voltage/input voltage) of the buck circuit is D, where D is a duty cycle of the control signal. Therefore, the buck circuit cannot output an output voltage higher than the input voltage.

The boost circuit and the buck circuit are respectively limited by the voltage conversion factors, so that, they cannot meet common driving requirements. For example, when a 7.4 V lithium battery is used as the input power source to drive two white LEDs connected in series, a 6-7 V driving voltage must be generated. At this time, the buck circuit architecture is needed. However, when the 7.4 V lithium battery is used to drive three white LEDs connected in series, a 10-11 V driving voltage must be generated. At this time, the boost circuit architecture is needed. Therefore, different conversion architectures are required according to different requirements in actual applications, which is quite inconvenient.

In view of the aforementioned problem, a buck-boost circuit, for example, SEPIC circuit is also used to drive the set of LEDs. FIG. 3 shows a conventional LED driving circuit using a SEPIC circuit. The circuit includes a controller 310 and a SEPIC converter circuit. The SEPIC converter circuit includes inductors 321 and 325, a switch 322, a diode 323 and capacitors 324 and 326. When the switch 322 is situated in the short circuit state, the inductor 321 stores the power from the input voltage. When the switch 321 is situated in the open circuit state, the power stored in the inductor 321 is transferred by the inductor 321 and the capacitor 324, and then transmitted to the capacitor 326 through the diode 323. The capacitor 326 stores the power from the inductor 321, and generates an output voltage, so as to drive a set of LEDs 330 to emit light. A resistor 341 is connected to the set of LEDs 330 for detecting the magnitude of the current flowing through the set of LEDs 330, and generating a feedback signal which is fed back to the controller 310. The controller 310 regulates a pulse width of the control signal according to the feedback signal, so as to control the current flowing through the set of LEDs 330 at a stable value, such that the set of LEDs 330 emits light stably. The voltage conversion factor (output voltage/input voltage) of the SEPIC circuit is D/(1−D), where D is a duty cycle of the control signal. When D>50%, the SEPIC circuit outputs an output voltage higher than the input voltage. On the contrary, when D<50%, the SEPIC circuit outputs an output voltage lower than the input voltage. Therefore, the SEPIC circuit provides an output higher or lower than the input voltage according to different requirements, which is quite convenient.

However, the SEPIC circuit needs an additional inductor and capacitor compared with the conventional boost or buck circuit, so the cost is higher, and the conversion efficiency is lower. Therefore, the SEPIC circuit still has defects in use.

### SUMMARY OF THE INVENTION

In view of the disadvantages of conventional DC/DC converters, the present invention is directed to provide a DC/DC converter capable of providing functions of both boost and buck circuits, which employs fewer components, so as to reduce the circuit cost.

The present invention is also directed to provide a high-efficiency DC/DC converter capable of providing functions of both boost and buck circuits.

The present invention is also directed to provide an LED driving circuit having a protection function is capable of providing functions of both buck and boost circuits to meet different driving requirements.

The present invention is also directed to provide a controller with a level regulation function, which regulates a detection signal of a DC/DC converter, so as to process the signal properly.

The present invention is also directed to provide a high-efficiency DC/DC boost converter, which is obtained from an architecture of the DC/DC converter of the present invention with the connection relation of a load being changed.

In accordance with the aforementioned and other objectives of the present invention, a DC/DC converter for driving a load is provided. The DC/DC converter includes a switch, an inductor, a capacitor and a controller. The switch includes a first terminal, a second terminal and a control terminal, wherein the first terminal is coupled to a DC input power, and the control terminal is coupled to a control signal, such that the switch is switched between open circuit state and short circuit state according to the control signal. One end of the inductor is coupled to the second terminal of the switch, and another end thereof is coupled to ground. A negative end of the rectifier element is coupled to a coupling point of the switch and the inductor. One end of the capacitor is coupled to a positive end of the rectifier element for providing an output voltage to drive the load, and another end thereof is coupled to the DC input power or coupled to ground. The controller is used to output the control signal.

The present invention also provides another DC/DC converter for driving a load. The DC/DC converter includes a switch, an inductor, a capacitor and a controller. The switch includes a first terminal, a second terminal and a control terminal, wherein the second terminal is coupled to ground, and the control terminal is coupled to a control signal, such that the switch is switched between open circuit and short circuit state according to the control signal. One end of the inductor is coupled to the first terminal of the switch, and another end thereof is coupled to a DC input power. A positive end of the rectifier element is coupled to a coupling point of the switch and the inductor. One end of the capacitor is coupled to a negative end of the rectifier element to provide an output voltage, and another end thereof is coupled to the DC input power or coupled to ground. The controller is used to output the control signal. One end of the load is coupled to the negative end of the rectifier element, and another end thereof is coupled to the DC input power.

The present invention also provides a DC/DC converter circuit for driving a load. The DC/DC converter circuit includes an inductor, a switch, a capacitor and a rectifier element. The switch includes a first terminal, a second terminal and a control terminal, and the switch and the inductor are coupled in series between a first common level and a second common level, wherein the first terminal of the switch is coupled to one end of the inductor. A first end of the capacitor is coupled to a first end of the load, a second end of the capacitor and a second end of the load are coupled to the first common level and the second common level respectively, and the first end of the capacitor provides an output voltage. One end of the rectifier element is coupled to the end of the inductor, and another end thereof is coupled to the first end of the capacitor. The control terminal of the switch is switched between open circuit state and short circuit state according to a control signal.

The present invention also provides another DC/DC converter circuit for driving a load. The DC/DC converter circuit includes an inductor, a switch, a capacitor and a rectifier element. The switch includes a first terminal, a second terminal and a control terminal, and the switch and the inductor are coupled in series between a first common level and a second common level, wherein the first terminal of the switch is coupled to one end of the inductor. A first end of the capacitor is coupled to a first end of the load, a second end of the capacitor is coupled to a second end of the load, and the second end of the capacitor is coupled to one of the first common level and the second common level. One end of the rectifier element is coupled to the end of the inductor, and the other end is coupled to the first end of the capacitor. The control terminal of the switch is switched between open circuit state and short circuit state according to a control signal.

The present invention also provides a controller for controlling a DC/DC converter circuit. The controller includes a level regulator, an error generator, an oscillator, a pulse width modulator and a driving circuit. The level regulator receives a detection signal to indicate an operating state of the DC/DC converter circuit, and regulates the level of the detection signal. The error generator generates an error signal according to the regulated detection signal and a reference voltage. The oscillator generates an oscillation signal. The pulse width modulator generates a pulse width modulation signal according to the error signal and the oscillation signal. The driving circuit generates a control signal according to the pulse width modulation signal, so as to control the DC/DC converter circuit.

In order to make the aforementioned and other objects, features and advantages of the present invention comprehensible, preferred embodiments accompanied with figures are described in detail below.

### BRIEF DESCRIPTION OF THE DRAWINGS

FIG. 1 is a schematic view of a conventional LED driving circuit using a boost circuit.

FIG. 2 is a schematic view of a conventional LED driving circuit using a buck circuit.

FIG. 3 is a schematic view of a conventional LED driving circuit using a SEPIC circuit.

FIG. 4 is a schematic view of a DC/DC converter according to a preferred embodiment of the present invention.

FIG. 5 is a schematic view of a DC/DC converter according to another preferred embodiment of the present invention.

FIG. 6 is a schematic view of a DC/DC converter according to still another preferred embodiment of the present invention.

FIG. 7 is a schematic view of a DC/DC converter according to yet another preferred embodiment of the present invention.

FIGS. 8A-8D are schematic views of the DC/DC converters modified according to FIGS. 4-7 respectively.

FIGS. 9A and 9B are schematic views of the DC/DC converters of FIGS. 4 and 6 respectively with the VDD pins of the controllers being coupled to the output voltage instead of the input voltage.

### DESCRIPTION OF EMBODIMENTS

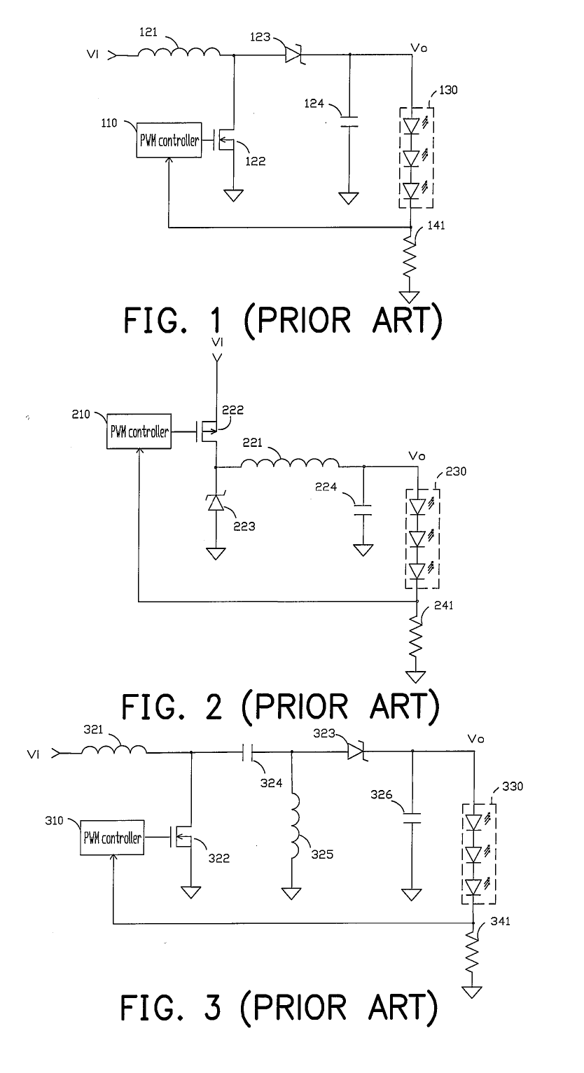

The voltage conversion factor (Vo/Vi) of the boost circuit of FIG. 1 is greater than 1 (1/(1−D), D=0˜1). If Vi is subtracted from the original output voltage Vo, the voltage conversion factor ranges from 0 to ∞ can be obtained, which can achieve buck-boost function. That is, Vo′/Vi=0˜∞, where Vo′=Vo−Vi.

FIG. 4 shows a preferred embodiment according to an embodiment of the present invention. Referring to FIG. 4, the DC/DC converter of FIG. 4 includes a controller 410, an inductor 421, a switch 422, a rectifier element 423, a capacitor 424, and a detection apparatus. The detection apparatus includes a current detection unit 441 and a voltage detection unit 442. The switch 422 includes a first terminal, a second terminal and a control terminal, wherein the second terminal is coupled to ground, and the control terminal is coupled to a control signal provided by the controller 410, such that the switch is switched between open circuit state and short circuit state according to the control signal. One end of the inductor 421 is coupled to the first terminal of the switch 422, and another end thereof is coupled to a DC input power Vin. A positive end of the rectifier element 423 is coupled to a coupling point of the switch 422 and the inductor 421 (i.e. the first terminal of the switch 422). One end of the capacitor 424 is coupled to a negative end of the rectifier element 423 to provide an output voltage, and another end thereof is coupled to ground. One end of the load 430 (here, the load is a set of LEDs) is coupled to the negative end of the rectifier element 423, and another end thereof is coupled to the DC input power Vin.

When the switch 422 is situated in the short circuit state, the inductor 421 stores the power from the input voltage. On the contrary, when the switch 422 is situated in the open circuit state, the inductor 421 transmits the stored power to the capacitor 424 and the load 430 through the rectifier element 423. The capacitor 424 stores the power from the inductor 421 when the switch 422 is situated in the open circuit state, and releases the stored power to the set of LEDs 430 when the switch 422 is situated in the short circuit state. By storing and releasing the power, a stable output voltage is outputted to drive the set of LEDs 430 to emit light continuously. The controller 410 obtains an operating state of the set of LEDs 430 according to a detection signal of the current detection unit 441 (i.e., the magnitude of the current), and regulates a duty cycle of the control signal according to the detection signal, so that the current flowing through the set of LEDs is stable at a predetermined value and the set of LEDs emits light stably. The voltage conversion factor of the DC/DC converter as shown in FIG. 4 is (Vout−Vin)/Vin=D/(1−D), where D=0˜1, so the factor ranges from 0 to ∞.

One end of the current detection unit 441 is coupled to the input voltage Vin, so a voltage level of the detection signal generated by the current detection unit 441 is higher than the input voltage Vin. The input voltage Vin provides power for the operation of the controller 410 as well in actual applications, and thus the detection signal cannot be directly processed by a conventional controller. In this embodiment, the detection signal is voltage-divided by a voltage divider unit and then processed. The voltage division apparatus can be built-in inside the controller (as shown in FIG. 4) or inside the current detection unit (as shown in FIG. 6).

The detailed operation of the interior of the controller 410 is described as follows.

The voltage-divided detection signal is coupled to a first input end of a level regulator 419a, and a second input end of the level regulator 419a receives a voltage division reference signal from a voltage division apparatus 418. The voltage division apparatus 418 is coupled to the input voltage Vin to generate the voltage division reference signal. Thus, the level regulator 419a regulates the level of the detection signal, so as to filter out the component of the input voltage Vin from the detection signal and then outputted it to an error generator 411. The level regulator 419a could be implemented by an analog adder/subtractor. The error generator 411 generates an error signal according to the regulated detection signal from the level regulator 419a and a reference voltage generated by a reference voltage generator 412. The error signal indicates the difference between the magnitude of the current flowing through the set of LEDs 430 and a predetermined value. A pulse width modulator 413 generates a pulse width modulation signal according to the error signal and a ramp signal generated by an oscillator 414. The pulse width of the pulse width modulation signal is regulated according to the amplitude of the error signal. A driving circuit 415 generates the control signal and regulates the pulse width of the control signal according to the pulse width modulation signal. When the current of the set of LEDs 430 is lower than the predetermined value, the pulse width of the control signal increases, such that the proportion of the turn-on time of the switch (an N-type metal-oxide-semiconductor field-effect transistor (NMOSFET) in this embodiment) increases, so as to transmit more power to the set of LEDs 430. When the current of the set of LEDs 430 is higher than the predetermined value, the pulse width of the control signal reduces, such that the proportion of the turn-on time of the switch reduces, so as to transmit less power to the set of LEDs 430. Thus, the current of the set of LEDs 430 is maintained near the predetermined value approximately.

The controller 410 further includes a dimmer 416 for receiving a dimming control signal, and controlling the control signal outputted from the driving circuit 415 according to the dimming control signal. Thus, the PWM dimming function is realized. Here, the dimming control signal is a DC signal or a pulse signal.

In addition, to prevent the converter from improper rise or fall of the output voltage of the converter circuit caused by short circuits, LED broken, or other abnormal reasons, the controller 410 further includes a protection circuit 417. The protection circuit 417 is coupled to a voltage detection signal generated by the voltage detection unit 442, and determines whether the output voltage Vout is lower than a first predetermined voltage or higher than a second predetermined voltage. The first predetermined voltage and the second predetermined voltage are provided by the reference voltage generator. When it is determined that the output voltage Vout is lower than a first predetermined voltage (under voltage state) or higher than a second predetermined voltage (over voltage state), a protection signal is outputted by the protection circuit 417 to the driving circuit 415 to stop the control signal outputting, such that the switch 422 stops switching. As the set of LEDs 430 is coupled between the output voltage Vout and the input voltage Vin, the voltage detection signal of the voltage detection unit 442, similar to the detection signal of the current detection unit 441, includes the components of the driving voltage of the set of LEDs 430 and the input voltage Vi. Therefore, the level regulation must be performed to filter out the component of the input voltage Vin. A first input terminal of a level regulator 419b receives the voltage detection signal, and a second input terminal receives the voltage division reference signal of the voltage dividing apparatus 418, so as to output the regulated voltage detection signal with no the component of the input voltage Vin to the protection circuit 417.

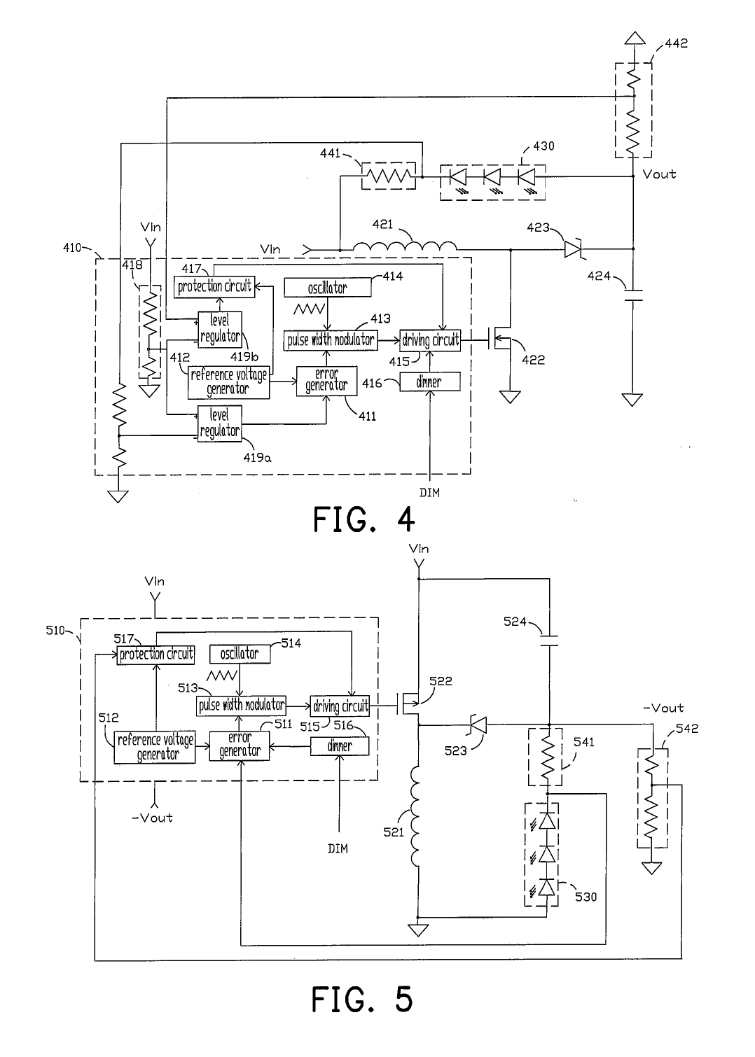

FIG. 5 is another preferred embodiment of the present invention. Different from FIG. 4, the output voltage converted by the converter of FIG. 5 is a negative voltage. The DC/DC converter of FIG. 5 includes a controller 510, an inductor 521, a switch (a P-type metal-oxide-semiconductor field-effect transistor (PMOSFET) in this embodiment) 522, a rectifier element 523, a capacitor 524 and a detection apparatus. The detection apparatus includes a current detection unit 541 and a voltage detection unit 542. The switch 522 includes a first terminal, a second terminal and a control terminal, wherein the first terminal is coupled to a DC input power Vin, and the control terminal is coupled to a control signal provided by the controller 510, such that the switch 522 is switched between open circuit state and short circuit state according to the control signal. One end of the inductor 521 is coupled to the second terminal of the switch 522, and another end thereof is coupled to ground. A negative end of the rectifier element 523 is coupled to a coupling point of the switch 522 and the inductor 521 (i.e., coupled to the second terminal of the switch 522). One end of the capacitor 524 is coupled to a positive end of the rectifier element 523 to provide an output voltage, and another end thereof is coupled to the DC input power Vin. One end of the set of LEDs 530 is coupled to a positive end of the rectifier element 523, and another end thereof is coupled to ground.

When the switch 522 is situated in the short circuit state, the inductor 521 stores the power from the input voltage. On the contrary, when the switch 521 is situated in the open circuit state, the inductor 521 transmits the stored power to the capacitor 524 and the set of LEDs 530 through the rectifier element 523. The capacitor 524 stores the power from the inductor 522 when the switch 521 is situated in the open circuit state, and releases the stored power to the set of LEDs 530 when the switch 522 is situated in the short circuit state. By storing and releasing the power, a stable output voltage is outputted to drive the set of LEDs 530 to emit light continuously. According to the volt-second balance: D*Vin=(1−D)*(−Vout), the voltage conversion factor (−Vout/Vin) of the DC/DC converter of FIG. 5 is D/(1−D), and ranges from 0 to ∞.

As the GND pin of the controller 510 of FIG. 5 is coupled to −Vout, the detection signal of the current detection unit 541 and the voltage detection signal of the voltage detection unit 542 can be directly and correctly processed. Thus, the level regulator of the controller 410 of FIG. 4 for regulating the detection signal and the voltage detection signal is not required. However, if the GND pin of the controller 510 is actually coupled to ground and the detection signal and the voltage detection signal are lower than the ground voltage, the controller 510 still has the problem that the detection signal and the voltage detection signal are beyond the processable range. Therefore, a level regulator is still required to regulate the detection signal and the voltage detection signal which are then provided to an error amplifier 511 and a protection circuit 517 respectively for processing.

The controller 510 of FIG. 5 includes an error generator 511, a reference voltage generator 512, a pulse width modulator 513, an oscillator 514 and a driving circuit 515. Moreover, the controller 510 could include a dimmer 516 for dimming, and further include a protection circuit 517 for providing protection from abnormal states, such as that the output voltage is over high or over low. The dimmer 516 of FIG. 5 receives a dimming control signal, and controls the level of an input end of the error amplifier 511 according to the dimming control signal, so as to control the control signal outputted from the driving circuit, and thus, the PWM dimming function is realized. In addition to the connections of FIGS. 4 and 5, the dimmer 516 can also be coupled to other elements, such as a pulse width modulator, to realize the PWM dimming, which is well known to persons skilled in the art. The principles of general operations and the protection operation of the controller 510 are the same as the controller 410 of FIG. 4, and the details will not described herein again.

The voltage conversion factor (Vo/Vi) of the buck circuit of FIG. 2 is D, where D=0˜1. If Vo is subtracted from the original input power Vi, Vo/Vi′=D/(1−D), then the voltage conversion factor ranges from 0 to ∞, where Vi′=Vi−Vo. Thus, the buck-boost functions is achieved.

FIG. 6 shows a preferred embodiment according to the aforementioned essence of the present invention. Referring to FIG. 6, in this embodiment, the input voltage Vin is Vi′ in the above description, and the output voltage Vout is Vo in the above description. The DC/DC converter of FIG. 6 includes a controller 610, an inductor 621, a switch 622, a rectifier element 623, a capacitor 624 and a detection apparatus. The detection apparatus includes a current detection unit 641 and a voltage detection unit 642. The connection relation of the elements is described as follows. The switch 622 includes a first terminal, a second terminal and a control terminal, wherein the second terminal is coupled to ground, and the control terminal is coupled to a control signal generated by the controller 610, such that the switch is switched between open circuit state and short circuit state according to the control signal. One end of the inductor 621 is coupled to the first terminal of the switch 622, and another end thereof is coupled to a DC input power Vin. A positive end of the rectifier element 623 is coupled to a coupling point of the switch 622 and the inductor 621 (i.e., coupled to the first terminal of the switch 622). One end of the capacitor 624 is coupled to a negative end of the rectifier element 623 to provide an output voltage, and another end thereof is coupled to the input voltage Vin. The set of LEDs 630 and the capacitor 624 are connected in parallel between the output voltage (i.e.: the negative end of the rectifier element 623) and the input voltage Vin.

When the switch 622 is situated in the short circuit state, the inductor 621 stores the power from the input voltage Vin. On the contrary, when the switch 621 is situated in the open circuit state, the inductor 621 transmits the stored power to the capacitor 624 and the set of LEDs 630 through the rectifier element 623. The capacitor 624 stores the power from the inductor 621 when the switch 622 is situated in the open circuit state, and releases the stored power to the set of LEDs 630 when the switch 622 is situated in the short circuit state. By storing and releasing the power, a stable output voltage is outputted to drive the set of LEDs 630 to emit light continuously. The voltage conversion factor of the DC/DC converter as shown in FIG. 6 is (Vout−Vin)/Vin=D/(1−D), where D=0˜1, so the factor ranges from 0 to ∞.

As the power supply pin (VDD pin) of the controller 610 in FIG. 6 is coupled to the input voltage Vin, and the detection signal generated by the current detection unit 641 and the voltage detection signal generated by the voltage detection unit 642 are higher than the input voltage Vin, the level regulator is required to regulate the level of the detection signal and the voltage detection signal which are then provided to the error amplifier 611 and the protection circuit 617 respectively for processing. The description of the level regulation is the same as the description of FIG. 4, and the details will not be described herein again.

The controller 610 of FIG. 6 includes an error generator 611, a reference voltage generator 612, a pulse width modulator 613, an oscillator 614 and a driving circuit 615. Moreover, the controller 610 could further include a dimmer 616 for dimming, and a protection circuit 617 for providing protection from abnormal states when the output voltage is over high or over low. The principles of general operations, the dimming operation and the protection operation of the controller 610, are the same as the controller in the above embodiment, and the details will not be described herein again.

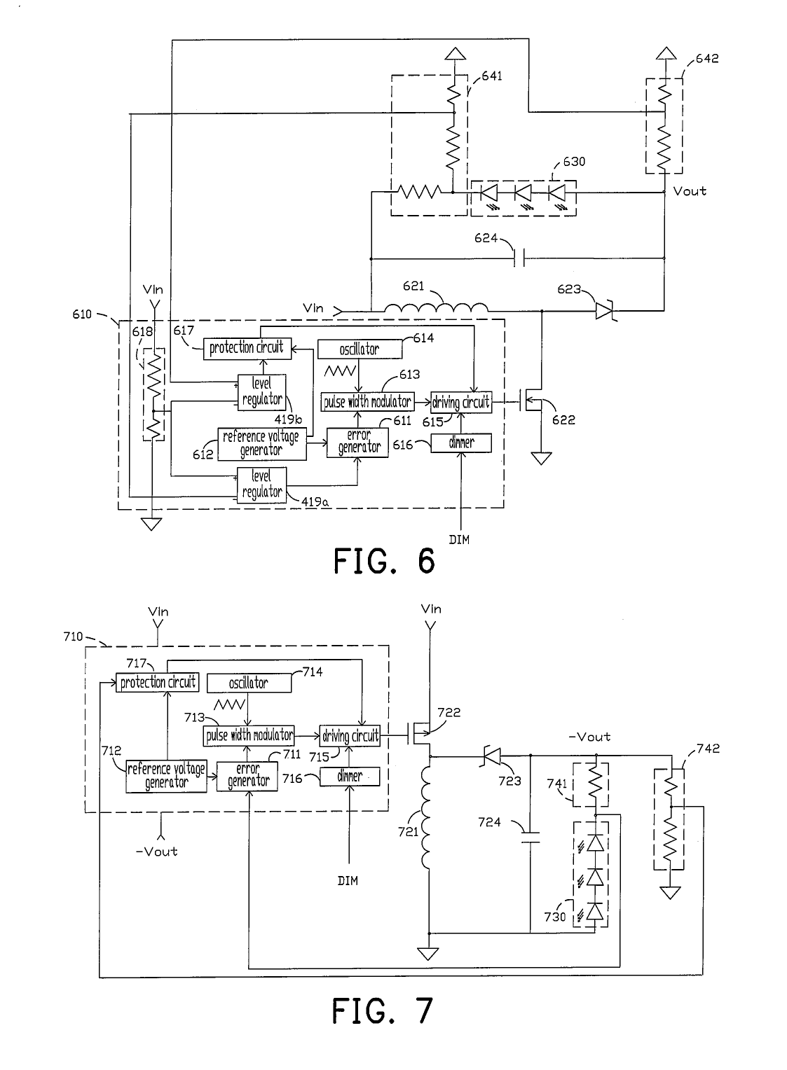

FIG. 7 is another preferred embodiment of the present invention. Different from FIG. 6, the output voltage converted by the converter circuit of FIG. 7 is a negative voltage. The DC/DC converter of FIG. 7 includes a controller 710, an inductor 721, a switch (a PMOSFET in this embodiment) 722, a rectifier element 723, a capacitor 724 and a detection apparatus. The detection apparatus includes a current detection unit 741 and a voltage detection unit 742. The connection relation of the elements is described as follows.

The switch 722 includes a first terminal, a second terminal and a control terminal, wherein the first terminal is coupled to a DC input power Vin, and the control terminal is coupled to a control signal generated by the controller 710, such that the switch 722 is switched between open circuit state and short circuit state according to the control signal. One end of the inductor 721 is coupled to the second terminal of the switch 722, and another end thereof is coupled to ground. A negative end of the rectifier element 723 is coupled to a coupling point of the switch 722 and the inductor 721 (i.e., coupled to the second terminal of the switch 722). One end of the capacitor 724 is coupled to a positive end of the rectifier element 723 to provide an output voltage, and another end thereof is coupled to ground. One end of the set of LEDs 730 is coupled to a positive end of the rectifier element 723, and another end thereof is coupled to ground.

When the switch 722 is situated in the short circuit state, the inductor 721 stores the power from the input voltage Vin. On the contrary, when the switch 722 is situated in the open circuit state, the inductor 721 transmits the stored power to the capacitor 724 and the set of LEDs 730 through the rectifier element 723. The capacitor 724 stores the power from the inductor 721 when the switch 722 is situated in the open circuit state, and releases the stored power to the set of LEDs 730 when the switch 722 is situated in the short circuit state. By storing and releasing the power, a stable output voltage is output to drive the set of LEDs 730 to emit light continuously. According to the volt-second balance: D*Vin=(1−D)*(−Vout), the voltage conversion factor (−Vout/Vin) of the DC/DC converter of FIG. 7 is D/(1−D), and ranges from 0 to ∞.

As the GND pin of the controller 710 of FIG. 7 is coupled to −Vout, the detection signal generated by the current detection unit 741 and the voltage detection signal generated by the voltage detection unit 742 can be directly processed correctly. Thus, the level regulator of the controller 610 of FIG. 6 for regulating the detection signal and the voltage detection signal is not required. However, if the GND pin of the controller 710 is actually coupled to ground, as the detection signal and the voltage detection signal are lower than the voltage level of the ground end, the controller 710 still has the problem that the detection signal and the voltage detection signal are out of the processing range. Therefore, a level regulator is still required to regulate the detection signal and the voltage detection signal which are then provided to and processed in an error amplifier 711 and a protection circuit 717 respectively.

The controller 710 of FIG. 7 includes an error generator 711, a reference voltage generator 712, a pulse width modulator 713, an oscillator 714 and a driving circuit 715. Moreover, the controller 710 could further include a dimmer 716 for dimming, and a protection circuit 717 for providing protection from abnormal states when the output voltage is over high or over low. The principles of general operations, the dimming operation, and the protection operation of the controller 710 are the same as the controller in the above embodiment, and the details will not be described herein again.

It is known from the above description that the DC/DC converter circuit of the present invention is based on the basic architecture of the conventional boost circuit and buck circuit, in which the connection relation of the elements to the output voltage, input voltage, or ground is changed, so as to obtain the DC/DC converter circuit having the buck/boost function. Compared with the convention buck-boost circuit, the present invention requires fewer elements, and has the conversion efficiency which is nearly the same as that of the conventional boost circuit or buck circuit and higher than the conventional SEPIC circuit. Compared with the conventional boost circuit or buck circuit, the DC/DC converter circuit of the present invention has both boost and buck functions. In actual applications, the present invention can meet more driving requirements, and is not limited to be used in boost or buck application only. Moreover, the present invention is particularly suitable for a LCD screen of a handheld apparatus using LEDs as a backlight source.

The converter circuits of FIGS. 4 and 6 and the converter circuits of FIGS. 5 and 7 are based on the conventional boost circuit and buck circuit respectively, while the difference is whether the capacitor is coupled to the input voltage Vin or coupled to ground. Whether the converter circuit is based on a boost circuit or a buck circuit, the capacitor is used to stabilize the output voltage. Therefore, one end of the capacitor must be coupled to one end of the load, and another end of the capacitor must be coupled to a stable voltage, i.e., the input voltage Vin (the first common level), or be coupled to ground (the second common level).

The common features of the embodiments of FIGS. 4-7 include that the inductor and the switch are coupled in series between the input voltage and the ground, i.e., between the first common level and the second common level. The difference of these embodiments is described as follows. In the embodiments of FIGS. 4 and 5, the load and the capacitor are also coupled in series between the input voltage and the ground (i.e., between the first common level and the second common level). The connection point of one end of the inductor and one end of the switch is coupled with the connection point of one end of the load and one end of the capacitor via the rectifier element. The other end of the inductor is coupled to the other end of the load. The other end of the capacitor is coupled to the other terminal of the switch. In the embodiments of FIGS. 6 and 7, the load and the capacitor are coupled in parallel. The first end of the capacitor is coupled to the connection point of one end of the inductor and one end of the switch via the rectifier element, and the other end of the capacitor is coupled to the other end of the inductor, i.e., coupled to the input voltage or the ground (i.e., one of the first common level and the second common level).

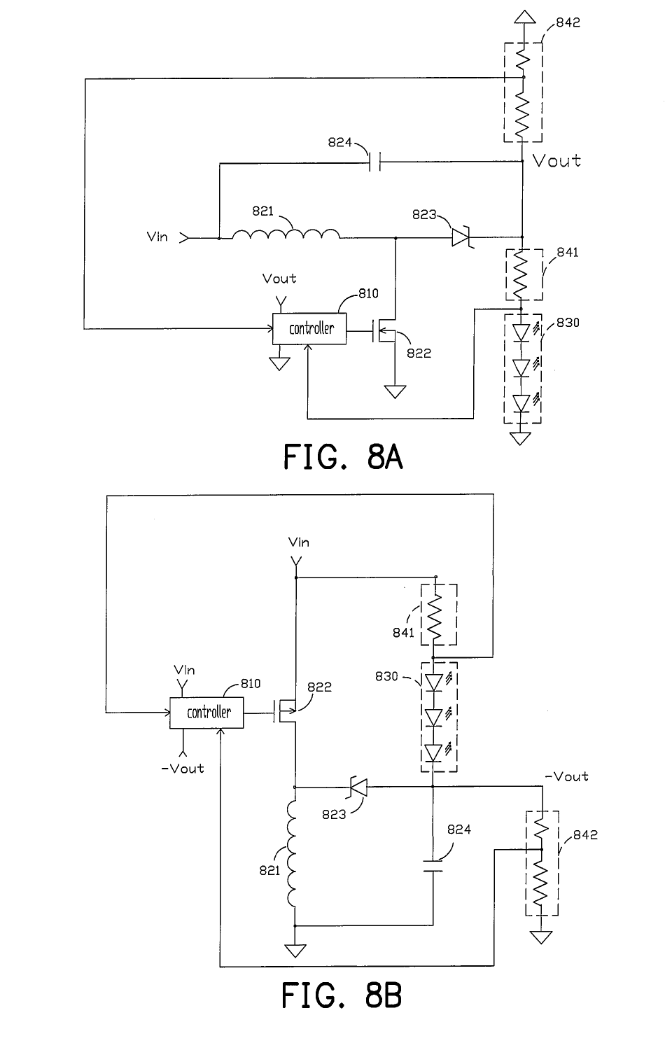

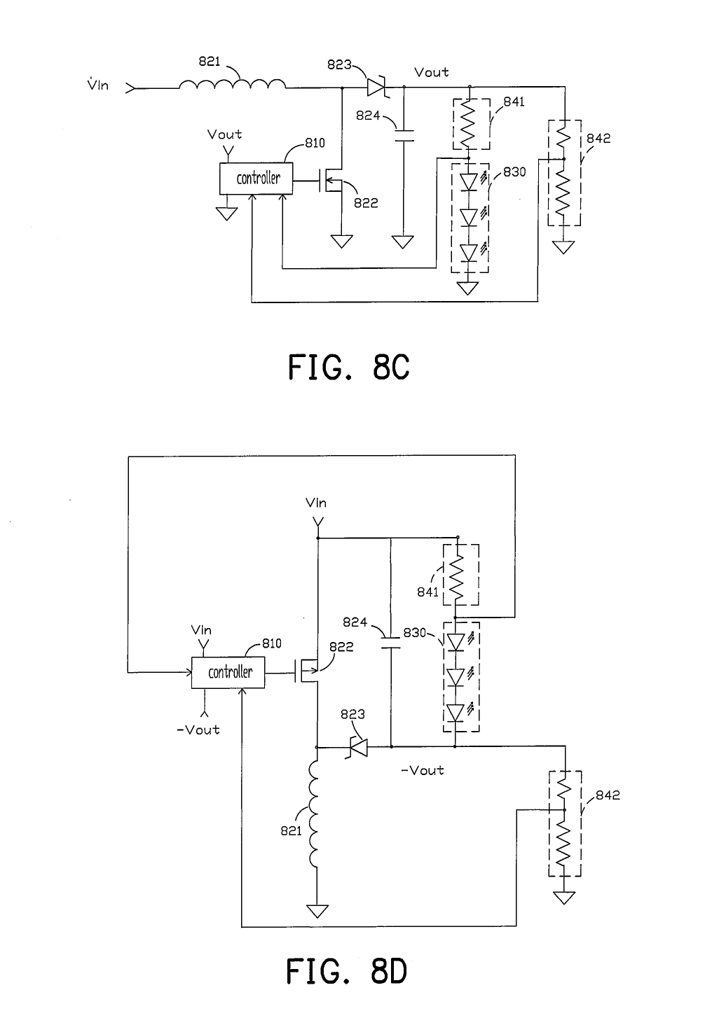

If the other end of the capacitor of FIGS. 4 and 5 is coupled to the other end of the inductor instead of being coupled to the other terminal of the switch (the other end of the load is coupled to the other terminal of the switch instead), referring to FIGS. 8A and 8B, the voltage conversion factor of the converter circuit is 1/(1−D), and thus the converter becomes a boost circuit. In FIG. 8A, the VDD pin of the controller 810 is coupled to the output voltage, and the GND pin is coupled to ground. In FIG. 8B, the VDD pin of the controller 810 is coupled to the input voltage, and the GND pin is coupled to the output voltage. As one of the GND pin and the VDD pin of the controller is coupled to the output voltage in FIGS. 8A and 8B, no matter whether the current detection circuit 841 is coupled between the capacitor 824 and the load 830 (as shown in FIG. 8A) or between the load 830 and the switch 822 (as shown in FIG. 8B), the controller 810 can process the detection signal of the current detection circuit 841 correctly, and does not require a level processor to regulate the level of the detection signal. Thus, the design of the circuit is more convenient. Moreover, referring to FIG. 8A, different from FIG. 1, the VDD pin of the controller 810 is changed to be coupled to Vout. Thus, the controller must be started with the power of the capacitor first. If the capacitor is still coupled to ground as shown in FIG. 1, the voltage of the capacitor will be lower than the value of subtracting a forward bias of the rectifier element 823 from the input voltage, which results in that the controller cannot be started normally. Therefore, one end of the capacitor 824 of FIG. 8A is coupled to the input voltage instead of being coupled to ground. Thus, the aforementioned problem of the conventional art is prevented.

Two ends of the voltage detection circuit 842 can be coupled to two ends of the capacitor as shown in FIG. 8A, or coupled to two ends of the controller 830 as shown in FIG. 8B. However, the voltage detection circuit 842 of FIG. 8B does not measure the cross voltage of the load 830 directly, so the voltage detection signal includes an extra component of the input voltage Vin, and the controller 810 must include a level regulator like the controller 410 of FIG. 4 or the controller 610 of FIG. 6, so as to regulate the level of the voltage detection signal and to filter out the component of the input voltage Vin. The voltage detection circuit 842 of FIG. 8A directly measures the cross voltage of the load 830, so the controller 810 does not need a level regulator. In addition, if the VDD pin and the GND pin of the controller 810 of FIGS. 8A and 8B are changed to be coupled to the input voltage and the ground respectively, the controller must include a level regulator for regulating the level of the voltage detection signal of the voltage detection circuit 842 to filter out the component of the input voltage Vin. In such case, the current detection circuit 841 can only be coupled between the load 830 and the switch 822, such that the controller 810 can process the detection signal of the current detection circuit 841 correctly.

Similarly, if the other end of the capacitor of FIGS. 6 and 7 is coupled to the other terminal of the switch instead of being coupled to the other end of the inductor, referring to FIGS. 8C and 8D, the voltage conversion factor of the converter circuit is 1/(1−D), and thus the converter circuit becomes a boost circuit. In FIG. 8C, the VDD pin of the controller 810 is coupled to the output voltage, and the GND pin is coupled to ground. In FIG. 8D, the VDD pin of the controller 810 is coupled to the input voltage, and the GND pin is coupled to the output voltage. As one of the GND pin and the VDD pin of the controller is coupled to the output voltage in FIGS. 8C and 8D, regardless whether the current detection circuit 841 is coupled between the output voltage and the load 830 (as shown in FIG. 8C) or between the load 830 and the input voltage Vin (as shown in FIG. 8D), the controller 810 can process the level of the detection signal of the current detection circuit 841 correctly, and does not require a level processor to regulate the level of the detection signal. Thus, the design of the circuit is more convenient.

Two ends of the voltage detection circuit 842 can be coupled to two ends of the load 830 as shown in FIG. 8C, or coupled to the output voltage (one end of the load 830) and the other end of the inductor as shown in FIG. 8D. However, the voltage detection circuit 842 of FIG. 8D does not measure the cross voltage of the load 830 directly, so the voltage detection signal includes an extra component of the input voltage Vin, and the controller 810 must include a level regulator like the controller 410 of FIG. 4 or the controller 610 of FIG. 6, so as to regulate the level of the voltage detection signal and to filter out the component of the input voltage Vin. The voltage detection circuit 842 of FIG. 8C directly measures the cross voltage of the load 830, so the controller 810 does not require a level regulator. In addition, if the VDD pin and the GND pin of the controller 810 of FIGS. 8C and 8D are changed to be coupled to the input voltage and the ground respectively, the controller must include a level regulator for regulating the level of the voltage detection signal of the voltage detection circuit 842 to filter out the component of the input voltage Vin. Here, the current detection circuit 841 can only be coupled between the load 830 and the switch 822, such that the controller 810 can process the detection signal of the current detection circuit 841 correctly.

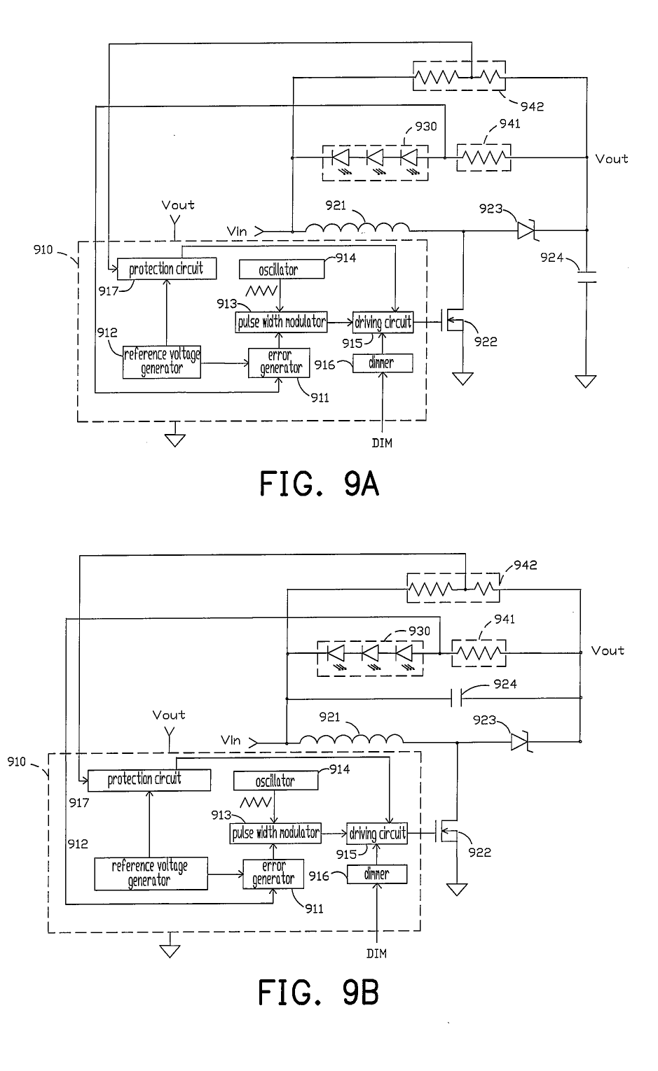

As shown in FIGS. 5 and 7, the GND of the controller is coupled to the output voltage to process the signal of the detection apparatus correctly. Similarly, after the VDD pin of the controller of FIGS. 4 and 6 is changed to be coupled to the output voltage (see FIGS. 9A and 9B) instead of being coupled to the input voltage, the controller can process the signal of the detection apparatus, and does not require a level regulator. In FIGS. 9A and 9B, one end of the capacitor 924 provides the output voltage, and one end of the load 930 is coupled to the input voltage Vin. One end of the current detection circuit 941 is coupled to the end of the capacitor 924, and another end of the current detection circuit 941 is coupled to the other end of the load 930. At this time, as the range of signal processing of the controller 910 is from 0 V to the output voltage Vout, the detection signal of the current detection circuit 941 can be processed correctly, and the level regulator is not required. On the contrary, the VDD pin of FIGS. 4 and 6 is coupled to the input voltage. In order to ensure a common level existing between the current detection circuit and controller, one end of the current detection circuit must be coupled to the input voltage (i.e., one end of the inductor), and another end thereof is coupled to the load. Thus, the detection signal is beyond the range of signal processing of the controller, and a level regulator is required to regulate the level of the signal. Two ends of the voltage detection circuit 942 are coupled to two ends of the load 930 respectively, and are connected in parallel with the load 930, so as to measure the actual cross voltage of the load 930 that does not include an extra component of the input voltage as FIG. 4. Definitely, it is true that the voltage detection circuit 942 measures an extra voltage drop caused by the current detection circuit 941. However, in fact, the voltage drop is extremely low, and can be ignored.

As the low level end of the load of the present invention (i.e., the negative end of the set of LEDs) may not be at the same level as the GND pin of the controller (e.g., the embodiments of FIGS. 4 and 5 are not at the same level), or the high level end of the load (i.e., the positive end of the set of LEDs) may not be at the same level as the VDD pin of the controller, it is possible that the detection signal of the current detection circuit is beyond the processing range of signal level, and thus the level regulation is required. In addition, the voltage detection circuit is used to detect whether the driving voltage across the load is too high or too low, and the voltage detection circuit must be connected in parallel to the load in principle. However, under the condition that an end of the voltage detection circuit must be at the same level as the VDD pin or the GND pin of the controller to ensure that the controller and the voltage detection signal have the same reference level (e.g., that shown in FIGS. 4, 6, 8B, 8D, or the GND pin of the controller in FIGS. 5 and 7 changed to couple to the ground), the voltage detection signal will include an extra component of the input voltage Vin, and must be compensated. The coupling relationship of the current detection circuit, the voltage detection circuit, the controller, and the load is described as follows. The coupling relationship allows the detection apparatus to detect the required signals properly and allows the controller to process the signals of the detection apparatus correctly.

To enable the generated signals to be processed by the controller properly, an end of the current detection circuit and an end of the voltage detection circuit must be coupled to the level to which the VDD pin and the GND pin of the controller are connected. Thus, the signals and the controller have a common level, such that the controller processes the signals based on the common level. The current detection circuit is connected in series to the load to detect the current flowing through the load. When one end of the current detection circuit is coupled to the negative end (i.e., the low level end) of the load, and another end thereof is coupled to the GND pin of the controller (as shown in FIGS. 5 and 7, the GND pin of the controller and the other end of the current detection circuit are both coupled to the output voltage, or as shown in FIG. 8A, the GND pin of the controller and the other end of the current detection circuit are both coupled to ground), or when one end of the current detection circuit is coupled to the positive end (i.e., the high level end) of the load, and another end thereof is coupled to the VDD pin of the controller (as shown in FIG. 8B, the VDD pin of the controller and the other end of the current detection circuit are both coupled to the input voltage, or as shown in FIGS. 9A and 9B, the VDD pin of the controller and the other end of the current detection circuit are both coupled to the output voltage), the detection signal of the current detection circuit does not include the component of the input voltage, and does not need the level regulation. However, when one end of the current detection circuit is coupled to the negative end of the load, and another end thereof is coupled to the VDD pin of the controller (as shown in FIGS. 4 and 6, the other end of the current detection circuit and the VDD pin of the controller are both coupled to the input voltage), or when one end of the current detection circuit is coupled to the positive end of the load, and another end thereof is coupled to the GND pin of the controller (as shown in FIGS. 5 and 7, when the GND pin of the controller is changed to couple to ground, one end of the current detection circuit must be changed to couple to the positive end of the load, and another end of the current detection circuit must be changed to be couple to ground), the detection signal of the current detection circuit will include the component of the input voltage and so the controller requires the level regulation.

To detect the over high or over low output voltage, one end of the voltage detection circuit must be coupled to the output voltage. When the controller is also coupled to the output voltage, the controller, the load, and the voltage detection circuit have a common level, and the voltage detection circuit can be connected in parallel to the load (and the current detection circuit connected in series). At this time, the voltage detection signal can detect the cross voltage of the load correctly, and the controller does not require the level regulation (as shown in FIGS. 5 and 7, the GND pin of the controller is coupled to the output voltage, or as shown in FIGS. 9A and 9B, the VDD pin of the controller is coupled to the output voltage). However, if the voltage detection circuit is not connected in parallel to the load (and the current detection circuit connected in series), and two ends of the voltage detection circuit are coupled to two ends of the capacitor respectively, the voltage detection signal will include an extra component of the input voltage and the controller requires the level regulation (,e.g., another end of the voltage detection circuit shown in FIGS. 5 and 7 is changed to couple to the input voltage Vin, or another end of the voltage detection circuit shown in FIGS. 4 and 6 is coupled to ground). When the controller is not coupled to the output voltage, and the VDD pin is coupled to the input voltage and the GND pin is coupled to ground, another end of the voltage detection circuit can be coupled to the input voltage or coupled to ground. However, the voltage detection signal definitely includes the component of the input voltage, and requires the level regulation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A DC/DC converter for driving a load, comprising:
an inductor, having a first terminal and a second terminal;
a switch, having a first terminal, a second terminal, and a control terminal, wherein the switch and the inductor are coupled in series between a first common level and a second common level, and the first terminal of the switch is coupled to the first terminal of the inductor;
a capacitor, having a first terminal is coupled to a first terminal of the load for providing an output voltage, and a second terminal of the capacitor and a second terminal of the load are respectively coupled to the first common level and the second common level; and
a rectifier element, having one terminal is coupled to the first terminal of the inductor and the other terminal thereof is coupled to the first terminal of the capacitor;
wherein the control terminal of the switch is switched between open circuit state and short circuit state according to a control signal.

2. The DC/DC converter of claim 1, wherein the second terminal of the capacitor is coupled to the second terminal of the switch.

3. The DC/DC converter of claim 2, further comprising a current detection circuit, for providing a detection signal, wherein one terminal of the current detection circuit is coupled to the first terminal of the load and the other terminal thereof is coupled to the first terminal of the capacitor.

4. The DC/DC converter of claim 3, further comprising a controller, for providing the control signal, wherein one of a ground (GND) pin and an input voltage (VDD) pin of the controller is coupled to the output voltage.

5. The DC/DC converter of claim 4, wherein the controller comprises:
an error generator, for generating an error signal according to the detection signal and a reference voltage;
an oscillator, for generating an oscillation signal;
a pulse width modulator, for generating a pulse width modulation signal according to the error signal and the oscillation signal; and
a driving circuit, for generating the control signal according to the pulse width modulation signal.

6. The DC/DC converter of claim 5, wherein the controller further comprises a dimmer, for receiving a light modulation control signal, and controlling whether or not to output the control signal according to the light modulation control signal.

7. The DC/DC converter of claim 2, further comprising a current detection circuit, for providing a detection signal, wherein one terminal of the current detection circuit is coupled to the second terminal of the load and the other terminal thereof is coupled to the second terminal of the inductor.

8. The DC/DC converter of claim 7, further comprising a controller, for providing the control signal, wherein a ground (GND) pin and an input voltage (VDD) pin of the controller are coupled to the first common level and the second common level respectively, and the controller comprises a level regulator for regulating the level of the detection signal.

9. The DC/DC converter of claim 8, wherein the controller comprises:
an error generator, for generating an error signal according to the detection signal and a reference voltage;
an oscillator, for generating an oscillation signal;
a pulse width modulator, for generating a pulse width modulation signal according to the error signal and the oscillation signal; and
a driving circuit, for generating the control signal according to the pulse width modulation signal.

10. The DC/DC converter of claim 9, wherein the controller further comprises a dimmer, for receiving a light modulation control signal, and controlling whether or not to output the control signal according to the light modulation control signal.

11. The DC/DC converter of claim 2, further comprising a voltage detection circuit, for providing a voltage detection signal, wherein one terminal of the voltage detection circuit is coupled to the first terminal of the load and the other terminal thereof is coupled to the second terminal of the load.

12. The DC/DC converter of claim 11, further comprising a controller, for providing the control signal, wherein one of a ground (GND) pin and an input voltage (VDD) pin of the controller is coupled to the output voltage.

13. The DC/DC converter of claim 12, wherein the controller comprises a protection circuit, when the voltage detection signal is lower than a first predetermined voltage or higher than a second predetermined voltage, the switch stops switching.

14. The DC/DC converter of claim 2, further comprising a voltage detection circuit, for providing a voltage detection signal, wherein one terminal of the voltage detection circuit is coupled to the first terminal of the capacitor and the other terminal thereof is coupled to the second terminal of the capacitor.

15. The DC/DC converter of in claim 2, further comprising a controller, for providing the control signal, wherein one of a ground (GND) pin and an input voltage (VDD) pin of the controller is coupled to the output voltage.

16. The DC/DC converter of claim 14, wherein the second terminal of the capacitor is coupled to the second terminal of the inductor.

17. The DC/DC converter of claim 16, further comprising a controller, for providing the control signal, wherein one of a ground (GND) pin and an input voltage (VDD) pin of the controller is coupled to the output voltage.

18. The DC/DC converter of claim 16, further comprising a voltage detection circuit, for providing a voltage detection signal, wherein one terminal of the voltage detection circuit is coupled to the first terminal of the load and the other terminal thereof is coupled to the second terminal of the load.

19. The DC/DC converter of claim 16, further comprising a voltage detection circuit, for providing a voltage detection signal, wherein one terminal of the voltage detection circuit is coupled to the first terminal of the capacitor and the other terminal thereof is coupled to the second terminal of the capacitor.

20. The DC/DC converter of claim 19, wherein the controller comprises a level regulator, for regulating the level of the voltage detection signal.

21. The DC/DC converter of claim 16, further comprising a controller, for providing the control signal, wherein an input voltage (VDD) pin and a ground (GND) pin of the controller are coupled to a first common level and a second common level respectively, and the controller comprises a level regulator.

22. The DC/DC converter of claim 19, further comprising a current detection circuit, for providing a detection signal, wherein one terminal of the current detection circuit is coupled to the second terminal of the load and the other terminal thereof is coupled to the second terminal of the switch.

23. A DC/DC converter for driving a load, comprising:
an inductor, having a first terminal and a second terminal;
a switch, having a first terminal, a second terminal, and a control terminal, wherein the switch and the inductor are coupled in series between a first common level and a second common level, and the first terminal of the switch is coupled to the first terminal of the inductor;
a capacitor, having a first terminal coupled to a first terminal of the load and a second terminal coupled to a second terminal of the load, wherein the second terminal of the capacitor is coupled to one of the first common level and the second common level; and
a rectifier element, having one terminal coupled to the first terminal of the inductor and the other terminal coupled to the first terminal of the capacitor;
wherein the control terminal of the switch is switched between open circuit state and short circuit state according to a control signal.

24. The DC/DC converter of claim 23, wherein the second terminal of the capacitor is coupled to the second terminal of the inductor.

25. The DC/DC converter of claim 24, further comprising a current detection circuit, for providing a detection signal, wherein one terminal of the current detection circuit is coupled to the first terminal of the load and the other terminal thereof is coupled to the first terminal of the capacitor.

26. The DC/DC converter of claim 25, further comprising a controller, for providing the control signal, wherein one of a ground (GND) pin and an input voltage (VDD) pin of the controller is coupled to the output voltage.

27. The DC/DC converter of claim 26, wherein the controller comprises:
an error generator, for generating an error signal according to the detection signal and a reference voltage;
an oscillator, for generating an oscillation signal;
a pulse width modulator, for generating a pulse width modulation signal according to the error signal and the oscillation signal; and
a driving circuit, for generating the control signal according to the pulse width modulation signal.

28. The DC/DC converter of claim 27, wherein the controller further comprises a dimmer, for receiving a light modulation control signal, and controlling whether or not to output the control signal according to the light modulation control signal.

29. The DC/DC converter of claim 24, further comprising a current detection circuit, for providing a detection signal, wherein one terminal of the current detection circuit is coupled to the second terminal of the load and the other terminal thereof is coupled to the second terminal of the inductor.

30. The DC/DC converter of claim 29, further comprising a controller, for providing the control signal, wherein a ground (GND) pin and an input voltage (VDD) pin of the controller are coupled to the first common level and the second common level respectively, and the controller comprises a level regulator for regulating the level of the detection signal.

31. The DC/DC converter of claim 30, wherein the controller comprises:
an error generator, for generating an error signal according to the detection signal and a reference voltage;
an oscillator, for generating an oscillation signal;
a pulse width modulator, for generating a pulse width modulation signal according to the error signal and the oscillation signal; and
a driving circuit, for generating the control signal according to the pulse width modulation signal.

32. The DC/DC converter of claim 31, wherein the controller further comprises a dimmer, for receiving a light modulation control signal, and controlling whether or not to output the control signal according to the light modulation control signal.

33. The DC/DC converter of claim 24, further comprising a voltage detection circuit, for providing a voltage detection signal, wherein one terminal of the voltage detection circuit is coupled to the first terminal of the load and the other terminal thereof is coupled to the second terminal of the load.

34. The DC/DC converter of claim 33, further comprising a controller, for providing the control signal, wherein one of a ground (GND) pin and an input voltage (VDD) pin of the controller is coupled to the output voltage.

35. The DC/DC converter of claim 23, further comprising a controller, for providing the control signal, wherein one of a ground (GND) pin and an input voltage (VDD) pin of the controller is coupled to the output voltage, and the second terminal of the capacitor is coupled to the second terminal of the switch.

36. The DC/DC converter of claim 35, further comprising a voltage detection circuit, for providing a voltage detection signal, wherein one terminal of the voltage detection circuit is coupled to the first terminal of the load and the other terminal thereof is coupled to the second terminal of the load.

37. The DC/DC converter of claim 36, wherein the controller comprises a protection circuit, when the voltage detection signal is lower than a first predetermined voltage or higher than a second predetermined voltage, the switch stops switching.

38. The DC/DC converter of claim 35, further comprising a voltage detection circuit, for providing a voltage detection signal, wherein one terminal of the voltage detection circuit is coupled to the first terminal of the load and the other terminal thereof is coupled to the second terminal of the inductor.

39. The DC/DC converter of claim 38, wherein the controller comprises a level regulator for regulating the level of the voltage detection signal.

40. The DC/DC converter of claim 38, wherein the controller comprises a protection circuit, when the voltage detection signal is lower than a first predetermined voltage or higher than a second predetermined voltage, the switch stops switching.

41. The DC/DC converter of claim 23, further comprising a controller, for providing the control signal, wherein an input voltage (VDD) pin and a ground (GND) pin of the controller are coupled to a first common level and a second common level respectively, the controller comprises a level regulator, and the second terminal of the capacitor is coupled to the second terminal of the switch.

42. A controller for controlling a DC/DC converter circuit, said the controller comprising:
a level regulator, for receiving a detection signal to indicate an operating state of the DC/DC converter, and regulating the level of the detection signal;
an error generator, for generating an error signal according to the regulated detection signal and a reference voltage;
an oscillator, for generating an oscillation signal;
a pulse width modulator, for generating a pulse width modulation signal according to the error signal and the oscillation signal; and
a driving circuit, for generating a control signal according to the pulse width modulation signal to control the DC/DC converter.

43. The controller of claim 42, wherein the level regulator regulates the level of the detection signal according to a DC input voltage, and the DC input voltage is an input voltage of the DC/DC converter.

44. The controller of claim 42, further comprising a protection circuit, wherein the protection circuit receives a voltage detection signal indicating the output voltage of the DC/DC converter, and controls the driving circuit to stop or not the switch switching according to the voltage detection signal.

45. The controller of claim 44, wherein when the voltage detection signal is lower than a first predetermined value or higher than a second predetermined value, the driving circuit stops the switch switching.

46. The controller of claim 44, wherein the voltage detection signal is level-regulated by the level regulator and then outputted to the protection circuit.

47. The controller of claim 44, wherein the level regulator regulates the level of the voltage detection signal according to a DC input voltage, wherein the DC input voltage is an input voltage of the DC/DC converter.
